(19) United States
(12) Patent Application Publication
(10) Pub. No.: US 2007/0178365 A1
(43) Pub. Date: Aug. 2, 2007

(54) Electrocatalyst for fuel cell-electrode, fuel cell using the same and method for producing electrocatalyst

(76) Inventors: Masatoshi Sugimasa, Tokai (JP); Haruo Akahoshi, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/528,652

(22) Filed: Sep. 28, 2006

(30) Foreign Application Priority Data
Feb. 1, 2006 (JP) 2006-024044

(51) Int. Cl. H01M 4/96; H01M 4/92; H01M 4/88; B01J 23/42; B01J 21/18

(52) U.S. Cl. 429/44; 502/185; 502/101; 502/339

(57) ABSTRACT

An electrocatalyst for use in a fuel cell includes a carbon material as base support. An intermediate support with surface asperities is provided at least on a portion of the surface of the carbon material. Pt or a Pt-containing alloy particles supported on the intermediate or on the intermediate and the carbon material.

### CLAIM OF PRIORITY

The present application claims priority from Japanese application serial no. 2006-24044, filed on Feb. 1, 2006, the content of which is hereby incorporated by reference into this application.

### FIELD OF THE INVENTION

The present invention relates to an electrocatalyst and a fuel cell provided with a membrane electrode assembly (hereinafter, abbreviated to “MEA”) with a diffusion layer, an anode, an electrolyte and a cathode. The fuel cell is configured that a liquid fuel is oxidized at an anode and oxygen is reduced at a cathode of the MEA.

### BACKGROUND OF THE INVENTION

Conventional secondary batteries often are required charging operation after consumption of a certain power, and required to prepare a battery charger and to have a relatively long charging time. Therefore, they still have various problems upon driving mobile equipment at any time, anywhere and for long time continuously. In the feature, improvement of still higher power density and energy of a power supply will be required in mobile equipment. That is, a power supply is required having a long continuous driving time for coping with the increasing amount of information, higher operation speed, and higher function. The necessity has been increased for a small-sized power generator not requiring charging, that is, a micro-power generator capable of easily supplementing fuels.

With the background described above, fuel cell power supplies are expected as those capable of coping with the demand described above. A fuel cell is a power generator constituted at least with a solid or liquid electrolyte and two electrodes for inducing desired electrochemical reactions, i.e., an anode and a cathode, and directly converting the chemical energy possessed by a fuel to an electric energy at a high efficiency under the effect of an electrode catalyst. As the fuel, hydrogen chemically transformed from fossil fuel or water, methanol, alkali hydride or hydrazine which is a liquid or solution in a usual circumstance, or dimethyl ether as a pressurized liquefied gas is used, and air or an oxygen gas is used as an oxidant gas.

The fuel is electrochemically oxidized at an anode and oxygen is reduced at a cathode to cause electric potential difference between both of the electrodes. In this case, when a load is applied as an external circuit on both electrodes, transfer of ions occurs in the electrolyte and an electric energy is taken out for the external load.

Among the fuel cells, a direct methanol fuel cell (DMFC) using a liquid fuel, and a metal hydride or hydrazine fuel cell have been noted as an effective small sized portable or mobile power supply since the volume energy density of the fuel cell is high. Particularly, DMFC using, as a fuel, methanol which can be handled with ease and expected for production from biomass in near future can be said to be a most ideal power supply system.

JP-A Nos. 2002-1095, 2002-305000, and 2003-93874 are proposed with an aim of improving the performance of the electrode catalyst.

In polymer electrolyte fuel cells operated at about a normal temperature, use of Pt is indispensable as a catalytic metal for promoting the cell reaction. On the other hand, since Pt is expensive, decrease in the amount of use is a major subject for practical use. Then, it has generally been devised such that Pt is reduced in the particle size and carried on a support to enhance a specific surface area per unit weight. At present, carbon black is used as a support material having a high specific surface area and a relatively high conductivity. However, since a number of pores with a diameter of about several nm are present on the surface of the carbon black. It has resulted in a problem in that Pt particles are buried in the pores and do not function as the catalyst along with development in the refinement of Pt in recent years.

As means for solving the problems described above, it has been attempted to use, as a support, carbon materials free of pores on the surface such as carbon nano-fibers. However, since such carbon materials have a low specific surface area, in a case where fine Pt particles are supported by a predetermined amount or more, the fine Pt particles are agglomerated to decrease a catalytically active surface area. Accordingly, it has been a subject of increasing the catalytically active surface area by making support under high dispersion and increase in the amount of support compatible.

The present invention intends to provide a catalyst material having a high catalytic activity while decreasing the amount of Pt by the improvement in the efficiency of utilizing catalytic metal particles having a high specific surface area, as well as provide a fuel cell with improved power density by using the same for a membrane electrode assembly (MEA) mounted to a fuel cell.

### SUMMARY OF THE INVENTION

The invention provides an electrocatalyst for use in a fuel cell including a carbon material having a planar surface, an intermediate (it's also referred as intermediate support) with surface asperities at least on a portion of the surface of the carbon material (it's also referred as base support), and Pt or a Pt-containing alloy particles supported on the intermediate or on the intermediate and the carbon material. Further, the invention provides an electrocatalyst for use in a fuel cell including a fibrous carbon, a metal of a not uniform thickness and adsorbing in an electrical joined state with the fibrous carbon to at least a portion of the surface of the fibrous carbon, and catalytic particles supported on the fibrous carbon and/or the metal. Further, the invention provides a membrane electrode assembly, and a fuel cell using the electrocatalyst described above. In the invention, the specific surface area can be increased by forming an intermediate having a structure of unevenness or not uniform thickness to the surface of the carbon material, and high catalytic activity can be obtained with a small amount of Pt by supporting a Pt/or a Pt-containing alloy to the intermediate.

A fuel cell of high power density can be provided while improving the efficiency of utilizing the catalytic metal and decreasing the amount of the catalytic metal to be used by using the electrocatalyst of the invention for the fuel cell.

### BRIEF DESCRIPTION OF THE DRAWINGS

FIG. 1 shows an Embodiment of a fuel cell power supply system according to the invention;

FIG. 2 shows an Embodiment for a structure of a fuel cell according to the invention;

FIG. 3 shows an outline of a fuel cell power supply with a cartridge holder according to the invention;

FIG. 4 shows an Embodiment of a fuel chamber structure according to the invention;

FIG. 5 shows an Embodiment of an exhaust gas module according to the invention;

FIG. 6 shows an Embodiment of a fuel chamber/exhaust gas module integrated structure according to the invention;

FIG. 7 shows an Embodiment of an anode end plate structure according to the invention;

FIG. 8 shows an Embodiment of a cathode end plate structure according to the invention;

FIG. 9 shows an Embodiment of a current collector/cathode end plate integrated structure according to the invention;

FIG. 10 shows an Embodiment of an anode current collector structure according to the invention;

FIG. 11 is a schematic view of a structural model of a catalyst material according to the invention;

FIG. 12 is a schematic view for a structure of MEA and a diffusion layer according to the invention;

FIG. 13 shows an Embodiment of a gasket structure according to the invention;

FIG. 14 shows an Embodiment of the outline of a fuel cell according to the invention;

FIG. 15 shows an Embodiment of a structure in which MEA is disposed to an integrated fuel chamber/anode end plate according to the invention;

FIG. 16 shows an Embodiment of a cathode end plate structure with a current collector according to the invention; and

FIG. 17 shows an Embodiment of a structure of a mobile information terminal having a fuel cell according to the invention mounted thereto.

### DETAILED DESCRIPTION OF THE PREFERRED EMBODIMENTS

Preferred embodiments of the invention will be described hereinafter but the invention is not restricted to the following embodiments. In the following embodiments, while methanol is used as a fuel, hydrogen or a hydrogen containing gas may also be used.

In the fuel cell having methanol as a fuel used in this embodiment, electric power is generated in a way of directly converting the chemical energy possessed in the methanol into the electric energy by the electrochemical reaction shown below. On the anode, an aqueous methanol solution supplied takes place reaction in accordance with the formula (1) and is dissociated into carbon dioxide gas, hydrogen ions, and electrons (oxidation reaction of methanol).

CH₃OH+H₂O→CO₂+6H⁺+6e⁻ (1)

Formed hydrogen ions move from the anode through the electrolyte to the cathode and react with an oxygen gas that diffuses from air on the cathode electrode in accordance with the formula (2) to produce water (reduction reaction of oxygen).

6H⁺+3/2O₂+6e⁻→3H₂O (2)

Accordingly, in the entire chemical reaction upon power generation, methanol is oxidized with oxygen to form carbon dioxide gas and water as shown in the formula (3) and the chemical reaction scheme is identical with that of flame combustion of methanol.

CH₃OH+3/2O₂→CO₂+3H₂O (3)

Examples of a fuel cell according to the embodiment are to be described specifically.

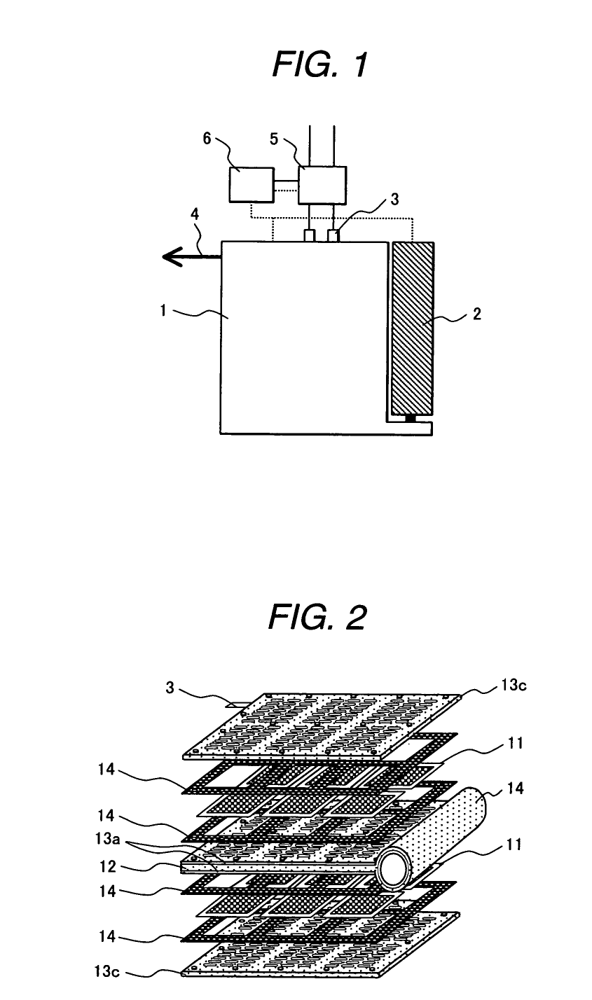

FIG. 1 shows a constitution of a power supply system according to this Embodiment. The power supply system includes a fuel cell 1, a fuel cartridge tank 2, an output terminal 3, and an exhaust gas port 4. The exhaust gas port 4 is formed for exhausting a carbon dioxide gas formed on the anode from a fuel chamber 12 (FIG. 2). The fuel cartridge tank 2 adopts a system of feeding a fuel by a pressure such as of a high pressure liquefied gas, a high pressure gas, or a spring, in which the fuel is fed to the fuel chamber 12 disclosed in FIG. 2 and the inside of the fuel chamber is kept by the liquid fuel to a pressure higher than the atmospheric pressure. As the fuel in the fuel chamber 12 is consumed along with power generation, a fuel is fed corresponding to the consumed amount from the fuel cartridge tank 2 under a pressure. In this system, the cell output is supplied by way of a DC/DC converter 5 to a load equipment, and the power supply system includes a controller 6 which is adopted to control the DC/DC converter 5 and, optionally, output a warning signal by obtaining signals that concern the situation during operation and upon stopping, for example, of the fuel cell 1, fuel residual amount in the fuel cartridge tank 2, DC/DC converter 5, etc. Further, the controller 6 can optionally display the operation state of the power supply such as cell voltage, output current, cell temperature, etc. In a case where the residual amount in the fuel cartridge tank 2 decreases to less than a predetermined value, or in a case where the air diffusion amount or the like is out of a predetermined range, the controller 6 stops the power supply from the DC/DC converter 5 to the load and drives abnormal warning such as sounds, voices, pilot lamps, or character display. Also during the normal operation, it can display the fuel residual amount to load equipment while receiving the fuel residual amount signal from the fuel cartridge tank 2.

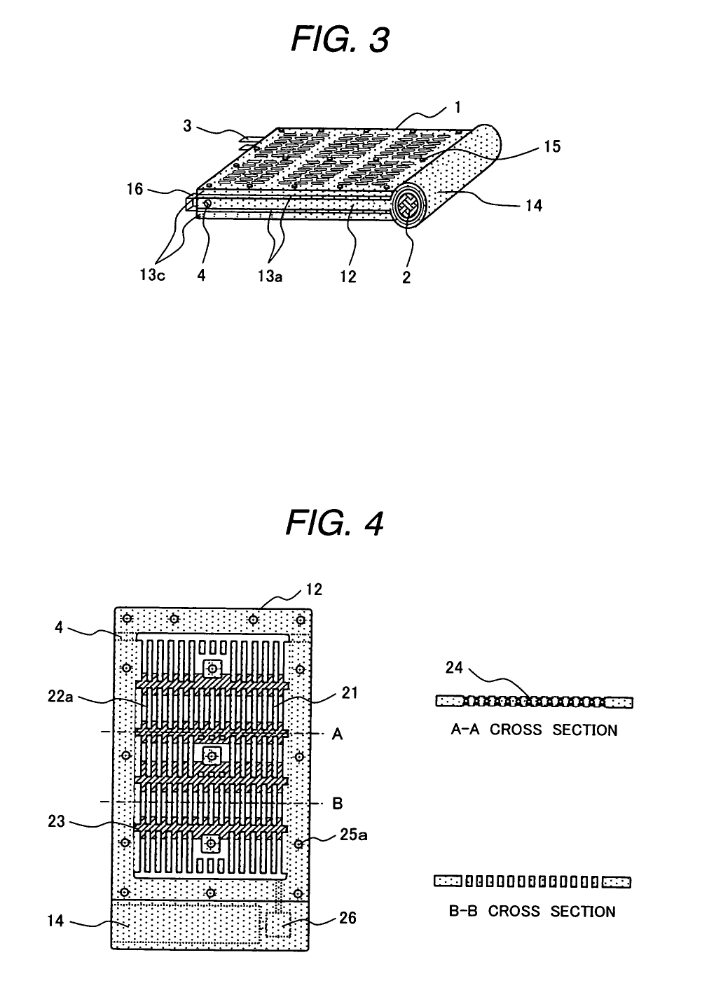

FIG. 2 shows a constitution of parts of a fuel cell according to an embodiment of the invention. The fuel cell includes a fuel chamber 12 having a fuel cartridge holder 14, and an anode end plate 13a, a gasket 17, MEA 11 with a diffusion layer, a gasket 17, and a cathode end plate 13c stacked successively in this order on one surface thereof, and also an anode end plate 13a, a gasket 17, MEA 11 with a diffusion layer, a gasket 17, and a cathode end plate 13c stacked in this order, also on the other surface of the fuel chamber 12, and the laminates are integrated and fixed with screws 15 such that the pressing force in the plane is substantially uniform (FIG. 3).

FIG. 3 shows an outline of a fuel cell 1 having an electric power generation section in which MEAs 11 by the number of six each having a diffusion layer are arranged on a plane on both sides of the stacked and fixed fuel chamber. The fuel cell 1 has a structure of serially connecting plural unit cells on both surfaces of a fuel chamber 12, a group of serially connected unit cells on both surfaces are further connected in series by a connection terminal 16 to take out a power from the output terminal 3.

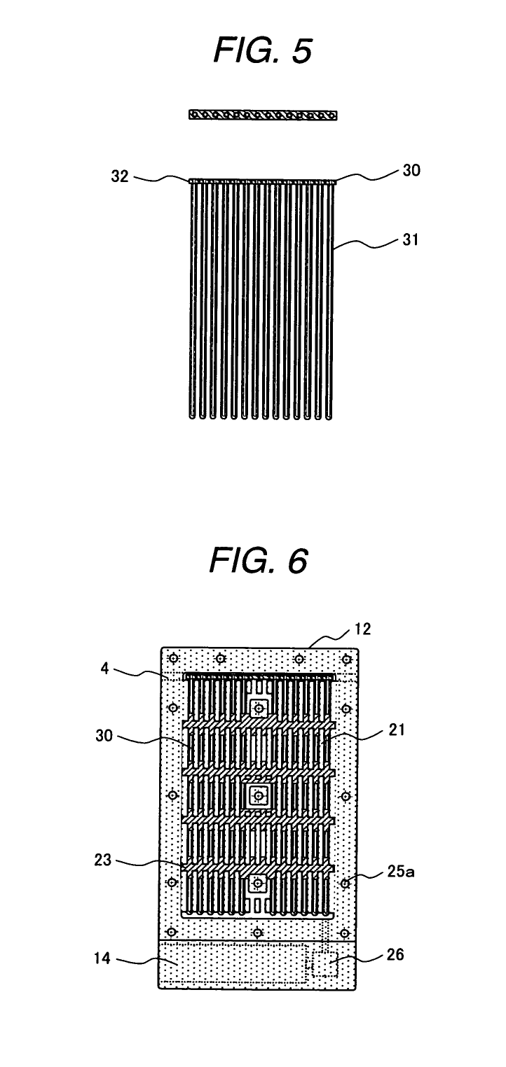

In FIG. 3, the fuel is fed under a pressure from the fuel cartridge tank 2 by a high pressure liquefied gas, a high pressure gas, or a spring. Carbon dioxide gas formed on the anode is exhausted from the exhaust gas port 4 by way of an exhaust gas module 30 which is not illustrated here but shown as an example in FIG. 5. The exhaust gas module 30 has a gas-liquid separation function and has a function of capturing an exhaust gas. On the other hand, air as an oxidant (cathode gas) is fed by diffusion from air diffusion slits 22c, and water formed on the cathode is diffused and exhausted through the slit 22c. The method of fastening for integrating the cell is not restricted to the screw-fastening disclosed in this embodiment but can also be obtained by inserting the cell into a casing and applying a compressive force from the casing or like other means.

FIG. 4 shows a structure of a fuel chamber 12 according to an embodiment of the invention. The fuel chamber 12 has a plurality of ribs 21 and slits 22a for distributing a fuel. The ribs 21 are supported by a rib support plate 23 so as to be disposed in plural in-line rows. The slits 22a are formed between respective ribs so as to pass through both sides of a rib support plate 23. The rib support plate with ribs and slits are fitted inside a frame of the fuel chamber 12. The thickness of the rib support plate 23 is sufficiently smaller than the thickness of the fuel chamber 12, and grooves for the distribution of the fuel are formed also in this portion, and the support plate is formed with support holes 24 for supporting gas-liquid separation tubes 31 shown in FIG. 5. Further, the fuel chamber 12 includes an exhaust gas port 4, screw holes 25a for clamping the cell, a fuel cartridge receptacle 26, and a fuel cartridge holder 14. The material for the fuel chamber 12 is not restricted particularly so long as it is smooth such that the surface pressure exerts uniformly upon mounting MEA, and it has a structure that plural cells disposed within the surface are insulated so as not to be short circuited to each other. High density vinyl chloride, high density polyethylenes, high density polypropylenes, epoxy resins, polyether ether ketones, polyethersulfones, polycarbonates, polyimide resins, or those formed by fiber-reinforcing them with glass fibers are used preferably. Further, it can also adopt a method of using carbon plate, steel, nickel and a light weight alloy material such as of aluminum or magnesium, or an inter-metallic compound typically represented by copper-aluminum and various kinds of stainless steels, and rendering the surface not electroconductive, or coating a resin thereby making the material insulative.

While the slits 22a for distributing a fluid such as a fuel or an oxidant gas have a parallel-groove structure in FIG. 3, other structure may also be selected and the structure is not particularly restricted so long as the fluid is uniformly distributed within a plane. Further, while the cell constituent members are uniformly clamped by the screws for electric connection and sealing of the liquid fuel, in FIG. 3, this is also not restricted to the example. For example, a method of bonding cell members to each other with adhesive polymeric films respectively and pressing and clamping the cell by the casing or the like is an effective method in view of reducing the weight and the thickness of the power supply.

FIG. 6 shows an outline of a fuel cell in which the fuel chamber 12 of the structure shown in FIG. 4 and the exhaust gas module 30 shown in FIG. 5 are combined as an example of the invention. Each of the gas-liquid separation tubes 31 of the exhaust gas module 30 is fixed through the support holes 24 of the rib support plate 23 provided in the fuel chamber 12. The module substrate 32 is connected with the exhaust gas port 4 and has a function of exhausting the gas recovered in each of the gas-liquid separation tubes 31 to the outside of the cell. With such a structure, the gas-liquid separation tube is disposed at the vicinity of the anodes about at an equal distance from two anodes opposed to each other in which the gaseous carbon dioxide is generated. When the fuel cartridge is mounted, the inside of the fuel chamber is filled with a fuel at a predetermined pressure. In a state of not generating power, since the fuel can not proceed into the pore of the gas-liquid separation tube until it reaches a predetermined pressure due to the water repellency of the gas-liquid separation tube. Therefore, the fuel does not leak at a predetermined pressure or lower. A carbon dioxide gas generated upon degassing of the dissolved gas in the fuel or carbon dioxide gas generated upon starting of power generation is captured by the gas-liquid separation tube and exhausted to the outside of the cell under the pressure of the liquid fuel. Accordingly, the film thickness, the average pore diameter, the pore distribution, and the opening rate of the gas-liquid separation tube used are selected for use depending on the initial pressure and the final pressure of the fuel cartridge, and the generation amount of the gaseous carbon dioxide at the maximum cell output.

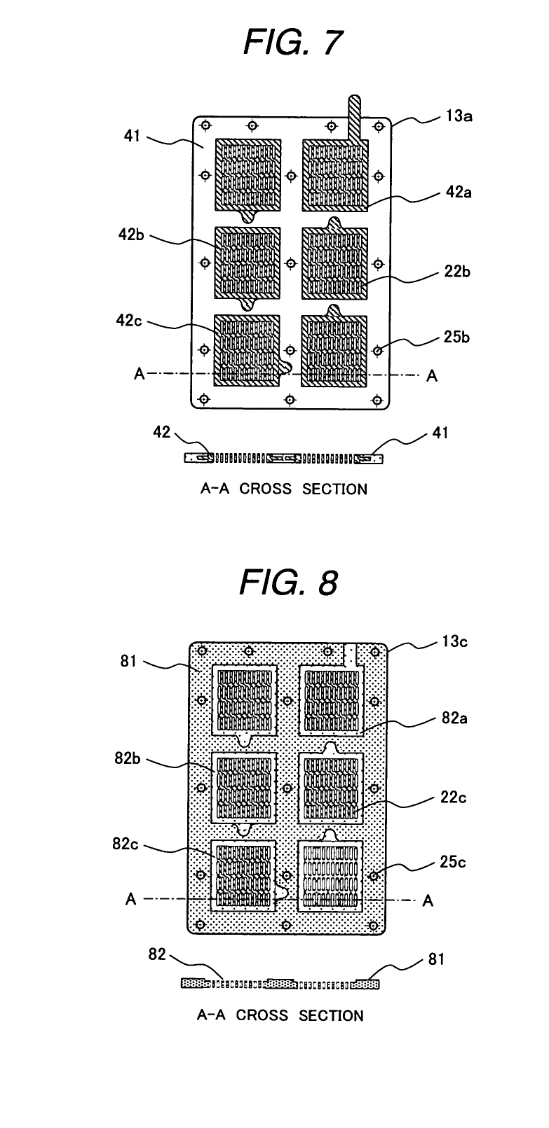

FIG. 7 shows a structure for an anode end plate 13a joined with a fuel chamber 12. In the anode end plate 13a, unit cells are arranged by the number of six within one identical plane, three types of electroconductive and corrosion resistant current collectors 42a, 42b, and 42c are integrated and joined for serial electric connection and an insulating sheet 41. A plurality of slits 22b are formed to the respective current collectors. The insulating sheet 41 is formed with a plurality of screw holes 25b for integrating and clamping cell parts.

Further, the insulating sheet 41 constituting the anode end plate 13a is not particularly restricted so long as it is made of a member to which the current collectors 42 arranged within a plane can be integrally joined respectively and which can ensure insulative property and planarity. High density vinyl chlorides, high density polyethylenes, high density polypropylenes, epoxy resins, polyether ether ketones, polyether sulfones, polycarbonates, polyimide resins or those formed by fiber-reinforcing them with glass fibers can be used preferably. Further, it can be joined with the current collectors 42 by using steel, nickel, as well as alloy materials of light weight aluminum or magnesium, or inter-metallic compounds typically represented by copper-aluminum or various kinds of stainless steels, by using a method of making the surface not electroconductive or a method of coating a resin for making it insulative.

FIG. 8 shows an example of a structure for a cathode end plate 13c in which a plurality of unit cells are arranged in series within an identical plane. The cathode end plate 13c is provided with counterbored portions 82a, 82b, 82c for joining a plurality of current collectors 42 to a substrate 81. In addition, the cathode end plate 13c is provided slits 22c for diffusing air as an oxidizing agent and steams as a product to the counterbored portion 82. Further, the cathode end plate 13c is formed with screw holes 25c for integrating and clamping fuel cell parts. The material for the substrate 81 is not particularly restricted so long as it can be joined with the current collectors 42 arranged in the plane, can ensure the insulating property and the planarity, further, has such a rigidity as capable of clamping within the plane to provide a sufficiently lower contact pressure relative to MEA. High density vinyl chlorides, high density polyethylenes, high density polypropylenes, epoxy resins, polyether ether ketones, polyether sulfones, polycarbonates, polyimide resins or those formed by fiber-reinforcing them with glass fibers are used preferably. Further, it can be joined with the current collectors 42 by using steel, nickel, as well as alloy materials of light weight aluminum or magnesium, or inter-metallic compounds typically represented by copper-aluminum or various kinds of stainless steels, by using a method of making the surface not electroconductive or a method of coating a resin for making it insulative.

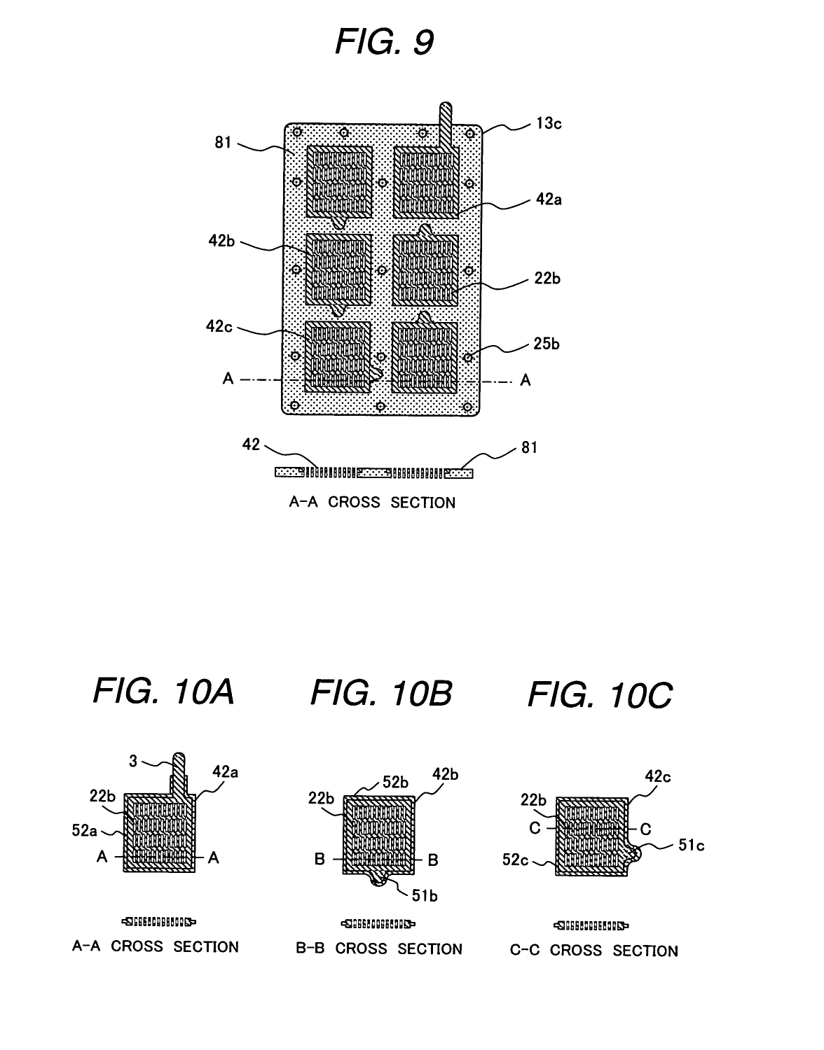

FIG. 9 shows an outline of a cathode end plate 13c, in which the current collectors shown in FIG. 10 are joined to the counterbored portions 82 of the substrate 81 shown in FIG. 8. The cathode end plate 13c is provided with current collectors 42 by the number of six in contact with the cathodes of unit cells by the number of six for current collection and screw holes 25c for integrating and clamping fuel cell parts within one identical plane. The current collector 42 is preferably fitted into the counterbored portions 82 and bonded with an adhesive so as to be in flush with the flange surface of the substrate as much as possible. The adhesive may be those not dissolved in and swollen with an aqueous methanol solution and electrochemically more stable than methanol. For example, an epoxy resin adhesive is suitable.

Further, fixing is not restricted to that by the adhesive but fixing can be attained also by disposing a protrusion to the substrate 81 that fits a portion of a slit 22b formed to the current collector 42 or a fitting hole formed specially to a portion of the counterbored portion. Further, it is not particularly restricted that the current collector 42 is in flush with one of the surfaces of the substrate 81. For example, in a case of a structure where a step is formed to the portion, the current collectors 42 can be joined with no provision of the counterbored portions 82 in the substrate 81 and this can be coped with by changing the structure and the thickness of the gasket used for sealing.

FIG. 10 shows a structure of a current collector to be joined with the anode end plate 13a and the cathode end plate 13c shown in FIG. 7 and FIG. 9. For serially connecting unit cells in one identical plane, three kinds of shapes 42a, 42b and 42c are used for the current collectors 42. The current collector 42a has a cell output terminal 3. A slit 22b is formed within the plane for diffusion of a fuel or air as an oxidizing agent. The current collectors 42b and 42c are provided with interconnectors 51b, 51c for serially connecting the unit cells within one identical plane and slits 22b. Further, in a case of using the collectors 42 for the anode end plate 13a, a fin 52 is provided for integrating and joining with the insulating sheet 41 shown in FIG. 7. In a case of using the same for the cathode end plate 13c, a structure not having the fin 52 is selected.

The material used for the current collector 42 is not particularly restricted. A carbon plate or a metal plate such as of stainless steel, titanium or tantalum, or a composite material of such metal material and a clad of other metal, for example, carbon steel, stainless steel, copper, nickel or the like can be used as the current collector. Further, in the metal current collector, a contact portion of a fabricated current collector may be given plating of a corrosion resistance noble metal such as gold. Or the contact portion may be given coating of a conductive carbon material. Thereby, the current collector's contact resistance upon mounting can be effective lowered for improving the output density and ensuring the long time performance stability of the cell.

The anode catalyst of MEA according to the embodiment of the invention includes the following catalytic metal particles, for example, fine particles of a metal mixture of platinum and ruthenium, or a platinum/ruthenium alloy. Such catalytic metal particles are supported dispersively on a carbon powder support. On the other hand, the cathode catalyst includes fine platinum particles as catalytic metal particles. Such catalytic metal particles are also supported dispersingly on a carbon support. They are materials that can be manufactured and utilized easily.

However, when using conventional type catalysts, since the support thereof is made of carbon material with a plurality of pores on the surface such as carbon black, the fine catalytic metal particles are buried in the pores, accordingly the specific surface area of the catalyst decreases, and a great amount of the catalytic metal is necessary for obtaining a sufficient catalytic activity.

On the other hand, in carbon materials in which fine pores are not present on the surface, while the efficiency of utilizing the catalytic metal is improved, since the specific surface area per unit weight of the support is low, they involve the subject in view of highly dispersed support and high supported amount.

In order to cope with the above-mentioned subject, the electrocatalyst of this embodiment includes an intermediate (intermediate support) of a not uniform thickness or an intermediate with rugged surface asperities, in addition to a carbon material without or less fine pores as support (its also referred as poreless support or base support) and catalytic metal particles. The intermediate with surface asperities is provided on the surface of the poreless support where fine pores are not present. The catalytic metal particles are also supported on the surface asperities of the intermediate in addition to an exposed surface portion of the poreless support. That is, since the surface asperities of the intermediate substantially serves as at least a part of the surface of the support, the specific surface area of the support can be increased in the poreless support. Thereby a highly dispersed catalytic particles-support and increase in the supported amount of catalytic particles can be resulted, so that a high performance electrocatalyst with a high catalyst activity can be obtained while decreasing the amount of the catalytic metal to be used. Consequently the embodiment can attain the improvement for the efficiency of utilizing the catalytic metal. Such an electrocatalyst will be detailed concretely hereinafter.

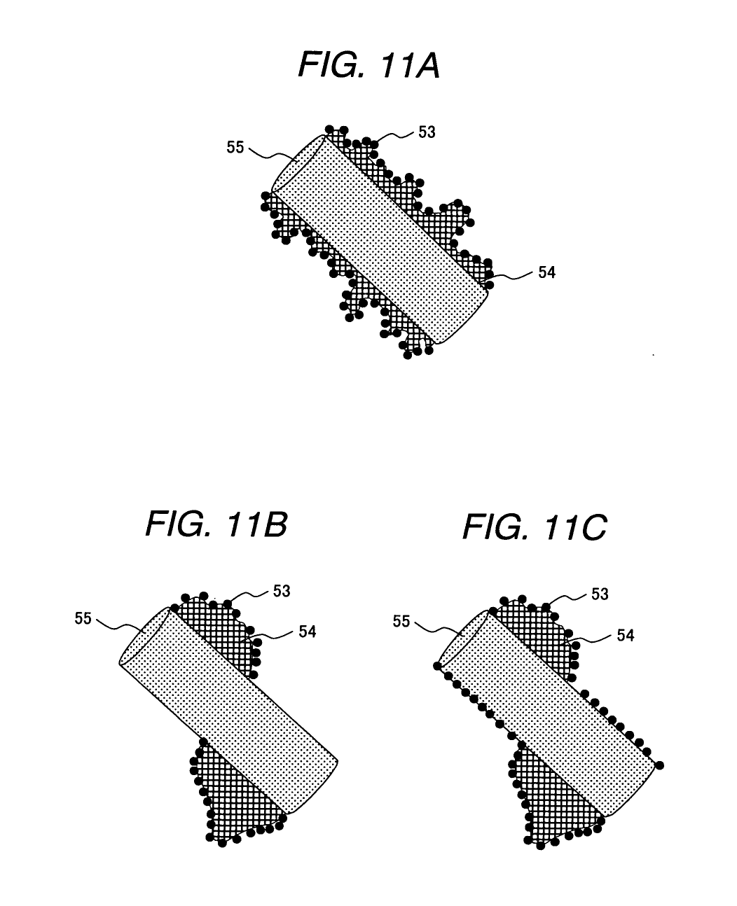

FIG. 11A shows an example of an ideal structural model of such an electrocatalyst according to the embodiment of the invention. In this case, the electrocatalyst material includes catalytic metal particle 53, an intermediate (intermediate support) 54 with surface asperities and a carbon material 55 as the support (base support).

FIG. 11A shows an embodiment in which an intermediate 54 is formed so as to coat the entire surface of the carbon material 55, and fine catalytic metal particles 53 are supported being highly dispersed on the surface of the intermediate 54. The intermediate 54 coating the entire surface of the carbon material 55 is most preferred as the electrocatalyst. FIG. 11B to FIG. 11C are examples of other expected structural models for the electrocatalyst in addition to the example in FIG. 11A. FIG. 11B shows an embodiment in which an intermediate 54 is disposed to a portion of the surface of a carbon material 55, and catalytic metal particles 53 are supported only on the surface of the intermediate 54. FIG. 11C shows an embodiment in which an intermediate 54 is disposed to a portion of a carbon material 55 and catalytic metal particles 53 are supported on the surfaces of an intermediate 54 and the carbon material 55. Those shown in FIG. 11B to 11C are somewhat inferior to that of FIG. 11A in view of the specific surface area as the support and the dispersibility of the catalytic metal particles 53 with that of FIG. 11A. But they are sometimes advantageous in view of the characteristics such as the catalyst activity per unit weight and adhesion with the electrolyte. With the constitution of FIGS. 11A to 11C, a specific surface area as the electrocatalyst can be increased outstandingly. The specific surface area can be controlled depending on the surface form, the material, and the amount of the intermediate 54. However, excess increase of the specific surface area is not desirable since this increases the difficulty in the process of forming the intermediate 54 and the process of supporting the catalytic metal particles 53. Further, such an increase of the specific surface area that the catalytic metal particles 53 are buried in the surface asperities of the intermediate 54 is not desirable also in view of the effective utilization of the catalytic metal particles 53. Then, the specific surface area per unit weight of the electrocatalyst comprising the constitution of FIG. 11A to 11C is preferably about 5 to 100 times the specific surface area of the carbon material 55.

The material of the intermediate 54 is not particularly restricted and metals and metal compounds are preferred with a view point of easy manufacture, manufacturing cost and stability. Preferred example for the metal materials includes Au, Ag, Cu, Pd, Rh, Ir, Ru, Os, Ni, Co, and Ti. The metals may also be used as alloys. Particularly, as the material of the electrode for use in a polymer electrolyte fuel cell, Pd, Rh, Ir, Ru, or Os excellent in acid resistance is preferred. Further, as the material for the anode, it is preferred to provide Ru having a co-catalysis effect to the CO oxidizing reaction as the intermediate 54. Examples of the metal compounds include preferably oxides, nitrides, sulfides borides, and silicides of Ti, W, Nb, and Ta in view of the aging stability and easy manufacture. Particularly, as the material of the electrode for use in the polymer electrolyte fuel cell, Ti oxides having high stability to acids and a CO oxidation co-catalyst effect are preferred. Oxides and nitrides of Si may also be used with a view point of easiness in the manufacturing process and stability against acids.

The shape of the intermediate 54 is not particularly restricted, and may be a polycrystal, a single crystal, or amorphous form. Referring to the ratio of the metal or the metal compound used as the intermediate 54, the specific surface area is insufficient if the ratio is too low, whereas it is disadvantageous in view of the catalyst activity per unit weight if the ratio is too large. Then, the ratio of metal or the metal compound used as the intermediate 54 is, preferably, from 50 to 90 wt % and, more preferably, from 50 to 70 wt % based on the entire weight of the catalyst material.

For the step of forming the intermediate 54, a method of using electrochemical reaction such as plating or electrodeposition in the liquid phase is preferred with a view point of easiness for the control in the manufacturing process, control for the surface shape, and the manufacturing cost. Particularly, since the reduction deposition process of a metal salt has already been established as a manufacturing process of a high specific surface area metal such as platinum black, this is desirable as a step of forming the intermediate 54. Further, the intermediate 54 may also be prepared by a method of supporting nano particles, or a sol-gel method. However, in the method described above, a care has to be taken for the manufacturing process so that the composition, the supported amount, and the surface area of products do not vary. Further, since the sol-gel method includes a heating process, the carbon material is sometimes degraded.

While there is no particular restriction on the material for forming the catalytic metal particles 53, in a case of use as the catalyst for a polymer electrolyte fuel cell used at a normal temperature, it is preferred to use Pt or a Pt-containing alloy having extremely high catalyst activity to a hydrogen or methanol oxidizing reaction and an oxygen reduction reaction. Particularly, in a case of using an alloy, since the catalyst activity differs greatly depending on the alloy composition, it is necessary to control the alloy composition in the manufacture of a highly active catalyst. While there is no particular restriction to the kind of the alloy, Ru having a co-catalyst effect relative to the Co oxidizing reaction is used preferably in a case of using the same for the anode of a polymer electrolyte fuel cell. However, in a case of using a material having a co-catalyst characteristic such as Ru for the intermediate 54, since a sufficiently high catalyst activity can be expected only with Pt for the catalytic metal particles 53, this is advantageous in view of the easiness in the manufacturing process and the material cost.

In the invention, since pores are not present in the support and Pt is supported only at the uppermost surface, the efficiency of effectively utilizing Pt that contributes to the reaction is high and a high catalyst activity can be attained even with a small amount of Pt to be used. Accordingly, since a practically sufficient catalyst activity is obtained at a ratio of Pt of from 1 to 25 wt % based on the entire weight of the catalyst material, this is advantageous when compared with the existent catalyst material in view of the cost. Further, as the supporting means for Pt or the Pt-containing alloy, the method of using electrochemical reaction in the liquid phase is preferred with a view point of controlling the supported amount and easiness in the process. Since the intermediate 54 and the catalytic metal particles 53 can be formed in one identical liquid phase, the liquid phase process is more advantageous compared with other processes with a view point of shortening the manufacturing time, easiness of control, cost, etc.

There is no particular restriction on the size and the form of the carbon material 55 used as the support, which may be any of plate, rod, porous, granular, or fibrous shape. The kind of the material includes, for example, porous carbon sheet, carbon paper, graphite, grassy carbon, carbon black, activated carbon, carbon fiber, or carbon nano tube. However, in the currently used catalytic metal particles 53, since the average grain size is refined as small as about 2 nm for the effective utilization and the cost reduction of the noble metal, the carbon material 55 of a large specific surface in which fine pores are present on the surface is not desirable. Because the fine catalytic metal particles 53 are buried and the utilization efficiency is lowered as described above. In view of the above, as the carbon material 55, a material having a specific surface area of from 1 to 200 m²/g, in which pores are not present on the surface or having a planar surface with the pores size of from 5 to 100 nm is preferred. The material includes, for example, fine graphite particle, carbon black of low specific surface area, activated carbon of low specific surface area, carbon fibers, and carbon nano tube. Further, in a case of using the material as the electrode for use in a fuel cell, since high conductivity is necessary, fibrous carbon fiber, carbon nano tube, etc. are suitable.

when using the carbon material 55 in which pores are little present on the surface, it is preferred to modify the surface of the carbon material 55 in order to improve adhesion with the intermediate 54. While there are various surface modification methods, a method of putting the carbon material 55 into a concentrated nitric acid or hydrogen peroxide and over heating the same to oxidize the surface is convenient. Further, it is more preferred to modify a functional group that contains an atom strongly adsorbing a metal such as a sulfur atom, a nitrogen atom, or an oxygen atom to the surface of the carbon material 55.

When a hydrogen ion conducting material is used for an electrolyte, a stable fuel cell can be attained free from the effect of carbon dioxide gas in atmospheric air. Such materials include materials formed by sulfonating fluoro polymers typically represented by polyperfluoro styrene sulfonic acids and prefluorocarbon sulfonic acids; materials formed by sulfonating hydrocarbon polymers such as polystyrene sulfonic acids, sulfonated polyethersulfones, and sulfoanted polyether ether ketons; or materials formed by alkyl sulfonating hydrocarbon polymers. When using those materials for the electrolyte, a fuel cell can be operated generally at a temperature of 80° C. or lower. Further, a fuel cell operating at a higher temperature region can be obtained by using a composite electrolyte formed by micro-dispersing a hydrogen ion conductive inorganic material such as tungsten oxide hydrate, zirconium oxide hydrate, or tin oxide hydrate into a heat resistant resin or sulfonated resin. Particularly, composite electrolytes using sulfonated polyether sulfones, sulfonated polyether ether sulfones, or hydrogen ion conductive inorganic materials are preferred as the electrolyte with lower permeability of the methanol fuel compared with polyperfluoro carbon sulfonic acids. Anyway, when using an electrolyte with high hydrogen ion conductivity and low methanol permeability, the utilization ratio of the fuel for electric power generation can be increased. Thereby fuel cell-compacting and the long time power generation as the effect of this embodiment can be attained at a higher level.

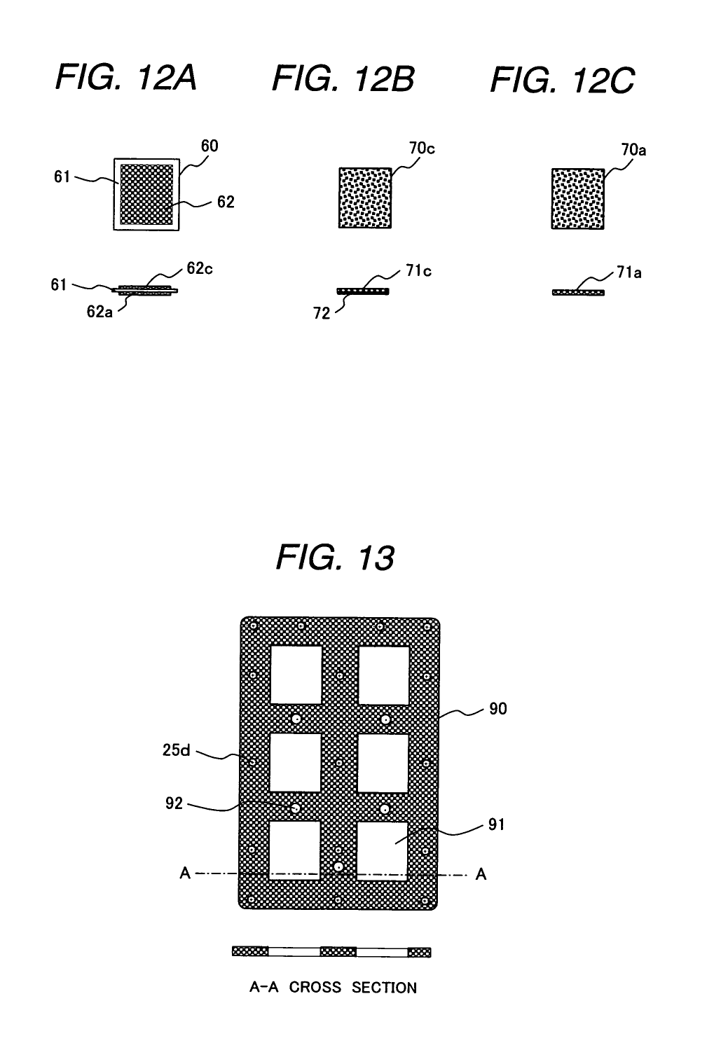

FIG. 12A shows a structure of MEA 60 used in the embodiment of the invention. An alkyl sulfonated polyether sulfone was used for an electrolyte 61. An electrocatalyst comprising platinum and ruthenium supported on a carbon support (XC72R: manufactured by Cabot Co.) was used for an anode 62a. An electro catalyst comprising platinum supported on a carbon support (XC72R: manufactured by Cabot Co.) was used for a cathode 62c. A polymer identical with the alkyl sulfonated polyether sulfone for the electrolyte and having smaller sulfonation equivalent weight than that of the electrolyte was used as the binder. By the selection of such a binder, the crossover amount of water and methanol of the electrolyte dispersed in the electrode catalyst can be increased, and the fuel dispersion on the electrode catalyst is promoted to improve the electrode performance.

FIG. 12B and FIG. 12C show the constitution of a cathode diffusion layer 70c and an anode diffusion layer 70a used in the invention. The cathode diffusion layer 70c comprises a water repellent layer 72 and a porous carbon substrate 71c. The water repellent layer 72 is used for enhancing water repellency to increase the steam pressure near the cathode. Thereby diffusive exhaustion of formed steams and condensation of water are prevented. The water repellent layer 72 is layered so as to be in contact with the cathode 62c. The surface contact for the anode diffusion layer 70a and the anode 62a is not particularly restricted and a porous carbon substrate was used. For the porous carbon substrate 71c of the cathode diffusion layer 70c, an electroconductive and porous material is used. Generally, woven fabric or non-woven fabric of carbon fibers, for example, carbon cloth (TORAYCACLOTH: manufactured by Toray Co.) or carbon paper (TGP-H-060: manufactured by Toray Co.), etc. are used as the carbon fiber woven cloth. The water repellent layer 72 is constituted by mixing a carbon powder and a water repellent fine particle, water repellent fibril or water repellent fiber, for example, polytetrafluoro ethylene.

Here manufacturing method of the cathode diffusion layer 70c is described concretely. A carbon paper (TGP-H-060: manufactured by Toray Co.) is cut out into a predetermined size. After previously determining the water absorption amount, the carbon paper is dipped in a liquid dispersion of polytetrafluoro carbon/water (D-1: manufactured by Daikin Kogyo Co.) such that the weight ratio after baking is 20 to 60 wt %, dried at 120° C. for about one hour, and further subjected to a baking operation in air at a temperature of from 270 to 360° C. for 0.5 to 1 hour. Then, a liquid dispersion of polytetrafluoro carbon/water was added to the carbon powder (XC-72R: manufactured by Cabot Co.) so as to be 20 to 60 wt % and kneaded. The kneading product in the form of a paste was coated on one side of the carbon paper rendered hydrophobic as described above to a thickness of from 10 to 30 μm. After drying the same at 120° C. for about one hour, it was baked at 270 to 360° C. for 0.5 to 1 hour in air to obtain a cathode diffusion layer 70c. Since the air permeability and moisture permeability of the cathode diffusion layer 70c, that is, the diffusibility of supplied oxygen and formed water of the same greatly depend on the addition amount, dispersibility and baking temperature of polytetrafluoro ethylene. Therefore appropriate conditions of the cathode diffusion layer 70c are selected on consideration of the design performance, the working circumstance, etc. of the fuel cell.

The material of the anode diffusion layer 70a is made of woven cloth or non-woven cloth of carbon fibers capable of satisfying the condition of the conductivity and the porosity. For example, carbon cloth (TORAYCACLOTH: manufactured by Toray Co.) or carbon paper (TGP-H-060: manufactured by Toray Co.) is preferred as the carbon fiber woven cloth. Since the function of the anode diffusion layer 70a is to promote the supply of an aqueous fuel solution and rapid releasing of the formed carbon dioxide gas, the following method for the anode diffusion layer is an effective method. That is a method of making the surface of the porous carbon substrate 71a hydrophilic by gradual oxidation or UV-ray irradiation; a method of dispersing a hydrophilic resin in a porous carbon substrate 71a; or a method of dispersingly supporting a strongly hydrophilic substance typically represented by titanium oxide. Such methods are an effective method of suppressing the growth of bubbles of carbon dioxide gas formed on the anode in the porous carbon substrate 71a and increasing the power density of the fuel cell. Further, the anode diffusion layer 70a is not restricted to the materials described above but porous materials of substantially electrochemically inactive metal materials (for example, stainless steel fiber non-woven fabric, porous body, porous titanium, tantalum, etc.) can also be used.

FIG. 13 shows a structure of a gasket 90 used for a fuel cell according to the invention. The gasket 90 includes a plurality of cut out-conductor portions 91 corresponding to the number of MEAs, screw holes 25d that allow clamping screws 25d to pass therethrough, and through holes 92. The through holes 92 are to allow conductor for connecting the interconnector 51 of the anode end plate 13a and the cathode end plate to pass therethrough. The gasket 90 is used for sealing a fuel fed to the anode 62a and an oxidant gas fed to the cathode 62c. Usual synthetic rubber such as EPDM, fluoro rubber, or silicon rubber, etc. can be used as the gasket member.

The electrocatalyst described above is to be described more specifically with reference to embodiments and comparative examples. In the embodiments, while an alloy of platinum and ruthenium is used as the catalytic metal, the catalytic metal is not restricted thereto but a catalytic metal having, for example, platinum can be used for the cathode of DMFC.

### Embodiment 1

Embodiment 1 is an example for an electrocatalyst for use in a DMFC electrode adopting the invention and a manufacturing method thereof. Carbon fiber (VGCF, manufactured by Showa Denko Co.) was selected for a carbon support, and platinum and ruthenium were selected for a supported metal. The manufacturing method is as described below.

At first, an Ru polycrystal layer was formed as an intermediate on VGCF. As the procedure, RuCl₃ and VGCF were added to a 0.1M NaOH solution such that the supported amount of Ru was 50 wt %, formalin as a reducing agent was added by 10 times or more than required amount and they were stirred at 60° C. for 2 hours to support Ru by reduction on the surface of VGCF. Then, the solution was filtered and washed, and vacuum-dried at 100° C. for 2 hours to obtain Ru-supported VGCF. As a result of ICP mass analysis, the supported amount of Ru was 48 wt %. As a result of XRD measurement, the crystallite size was about 2 nm. According to TEM observation, Ru polycrystal body with rugged surface asperities of about 10 to 300 nm was observed. As a result of BET measurement, the specific surface area of the Ru supported VGCF was 72 m²/g, which was 5.5 times the specific surface area of a single VGCF body (13 m²/g, according to BET measurement).

Then, PtRu was supported on the Ru supported VGCF. At first, the Ru supported VGCF was put into a 0.1M NaOH solution, after that, the solution is stirred to obtain a dispersed solution. Then, in order to obtain Pt supported amount of 20 wt % and Ru supported amount of 50 wt %, after keeping the temperature of the dispersed solution at 40° C., an aqueous solution of K₂PtCl₄ and an aqueous solution of RuCl₃ were added therein, furthermore formalin as a reducing agent was added by an amount twice the necessary amount. After that, they were stirred for 2 hours to support PtRu by reduction on the Ru supported VGCF surface. Then, they were filtered and washed with water to obtain a PtRu/Ru supported VGCF. As a result of ICP mass analysis, the supported amount of Pt and Ru were 20 wt % and 45 wt %.

Then, for evaluating the electrochemical characteristic as the anode catalyst for use in DMFC, measurement for the specific surface area of PtRu by adsorption and desorption of hydrogen ions and evaluation for the oxidation activity to methanol were conducted. As an evaluation method of the electrocatalyst for use in a fuel cell, a method of evaluation by preparing a membrane electrode assembly (MEA) is general. However, since the result differs greatly depending on the manufacturing process for MEA, it can not always be said that the catalyst activity is evaluated. Then, in this experiment, the following method was conducted with an aim of evaluating the electrochemical characteristic of a manufactured single PtRu/Ru supported VGCF body. At first, 10 mg of a PtRu/Ru supported VGCF was put between a carbon paper pair (manufactured by Toray Co.) and secured to a Pt mesh (manufactured by Nilaco Corp.) as a measuring electrode by using a jig. The jig was dipped in 1.5 mol/L of a sulfuric acid solution in the specific surface area measurement. In addition, the jig was dipped in a mixed solution formed by mixing 98% methanol with 1.5 mol/L of a sulfuric acid solution by 3:1 by volume ratio in the measurement for oxidation activity. Then a counter electrode and a reference electrode were put into the solution and nitrogen was introduced under stirring to remove oxygen in the solution.

Then, the potential on the active electrode was swept in a range from 0 to 0.5 V (vs. NHE) in the measurement for specific surface area. The specific surface area of PtRu was measured based on the value of a current peak inherent to PtRu formed by adsorption and desorption of hydrogen ions. In this method, only the specific surface area of PtRu in contact with the aqueous solution that contributes to the reaction can be measured. After measuring the specific surface area, the jig was dipped in the mixed solution of sulfuric acid and methanol described above and the amount of current flowing along with oxidation of methanol was measured by sweeping the potential on the Active electrode from 0 V (vs. NHE) at a rate of 1 mV/s in the positive direction and the oxidation activity was evaluated based on the value.

As a result of measuring 10 mg of the PtRu/Ru supported VGCF obtained in Embodiment 1, the specific surface area of PtRu showed a value as high as 1200 cm² (Table 1). Further, in the measurement of the oxidation current for methanol, the current started to flow from a potential as low as 0.4 V (vs. NHE). The methanol oxidation current at 0.7 V (vs. NHE) showed a value as high as 116 mA (Table 1). From the foregoing results, it was confirmed that the PtRu catalyst according to the invention with an increased specific surface area of the VGCF support had an excellent catalyst activity as the metal oxidation catalyst for use in DMC by the support of Ru.

### Embodiment 2

Embodiment 2 is an example of an electrocatalyst for use in a DMFC electrode using a multi-layered carbon nano tube (manufactured by the applicant per se, average diameter size: 200 nm) for support of the carbon material. Other materials than the carbon material were prepared under the same conditions as those in Embodiment 1. Table 1 shows the result of the characteristic evaluation in Embodiment 2. Any of them showed excellent characteristic like in Embodiment 1 and it was confirmed that the electrocatalyst using the multi-layered carbon nano tube as the carbon material had a high activity as the methanol oxidation catalyst for use in DMFC.

### Embodiment 3

Embodiment 3 is an example of an electrocatalyst for use in the DMFC electrode using a carbon black of low specific surface area (manufactured by Mitsubishi Chemical Co. BET specific surface area: 100 m²/g) as the carbon material. Other materials than the carbon material were prepared under the same conditions as those in Embodiment 1. Table 1 shows the result of the characteristic evaluation in Embodiment 3. Any of them showed excellent characteristic like in Embodiment 1 and it was confirmed that the catalyst material using the carbon black of low specific surface area for the carbon material had a high activity as the methanol oxidation catalyst for use in DMFC.

### Embodiments 4 to 6

Embodiments 4 to 6 are examples for electrocatalysts for use in the DMFC electrode in which a polycrystal layers of Pd, Rh, and Ir were deposited instead of Ru as the intermediate to increase the specific surface area of VGCF. They were manufactured under same conditions as those in Embodiment 1 except for the kinds of the polycrystal layers. Table 1 shows the result of evaluation for the characteristics of Embodiments 4 to 6. They showed excellent characteristics like in Embodiment 1.

### Embodiment 7

Embodiment 7 is an example of an electrocatalyst for use in the DMFC electrode in which Pt was supported instead of PtRu on the surface of the Ru polycrystal layer. They were prepared under the same conditions as those in Embodiment 1 except for PtRu and Pt at the uppermost surface. Table 1 shows the result of evaluation for the characteristic of Embodiment 7. They show excellent characteristic as in Embodiment 1 and it was confirmed that they had high methanol oxidation activity even when Pt was supported solely on the Ru surface.

### Embodiments 8, 9

Embodiments 8, 9 are examples of electrocatalysts for use in the DMFC electrode where the Pt-amount of the PtRu supported on the surface of the Ru polycrystal layer surface is changed to 10 wt % and 18 wt % based on the entire weight of the catalyst. They were prepared under the same conditions as those in Embodiment 1 except for the amount of Pt. Table 1 shows the result for the evaluation of the characteristic of Embodiments 8, 9. They showed excellent characteristics like in Embodiment 1.

### Embodiment 10

Embodiment 10 is an example of an electrocatalyst material for use in the DMFC electrode of depositing Ti oxide instead of Ru as the intermediate and increasing the specific surface area of VGCF. It was prepared under the same conditions as those in Embodiment 1 except for the kind of the polycrystal layer. A Ti oxide layer was formed by impregnating titania gel to a predetermined amount of VGCF and heating it in air at 450° C. for 30 min. Table 1 shows the result of evaluation for the characteristic of Embodiment 10. This showed excellent characteristic like in Embodiment 1.

### COMPARATIVE EXAMPLE 1

Comparative Example 1 is an example of an electrocatalyst supporting PtRu on VGCF. Pt and Ru were supported by the same method as in Embodiment 1. The supported amount of Pt was 20 wt % and the supported amount of Ru was 10 wt %. Table 1 shows the result of evaluation for the characteristic. It can be seen that the specific surface area of PtRu was as small as 800 cm² and the methanol oxidation current was as low as 66 mA.

### COMPARATIVE EXAMPLE 2

Comparative Example 2 is an example of an electrocatalyst supporting PtRu on a carbon black (Vulcan XC72R, manufactured by Cabot Co., specific surface area: 254 m²/g). Pt and Ru were deposited by the same method as in Embodiment 1. The supported amount of Pt was 20 wt % and the supported amount of Ru was 10 wt %. Table 1 shows the result of evaluation for characteristics. It can be seen that while the specific surface area of PtRu showed a high value like in Embodiment 1, the methanol oxidation current was as low as 83 mA.

TABLE 1

| | PtRu specific | Methanol oxidation |
|---|---|---|
| | surface area (cm²) | current (mA) |
| Embodiment 1 | 1200 | 116 |
| Embodiment 2 | 1200 | 113 |
| Embodiment 3 | 1300 | 115 |
| Embodiment 4 | 1100 | 110 |
| Embodiment 5 | 1200 | 115 |
| Embodiment 6 | 1100 | 113 |
| Embodiment 7 | 1300 | 120 |
| Embodiment 8 | 1200 | 110 |
| Embodiment 9 | 1100 | 115 |
| Embodiment 10 | 1500 | 110 |
| Comp. Example 1 | 800 | 66 |
| Comp. Example 2 | 1200 | 83 |

### Embodiment 11

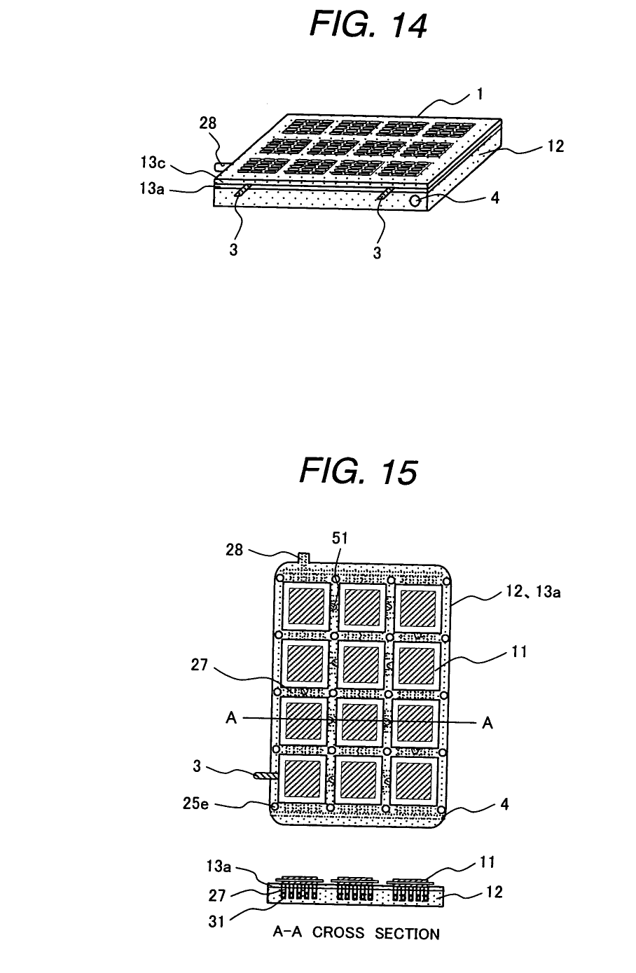

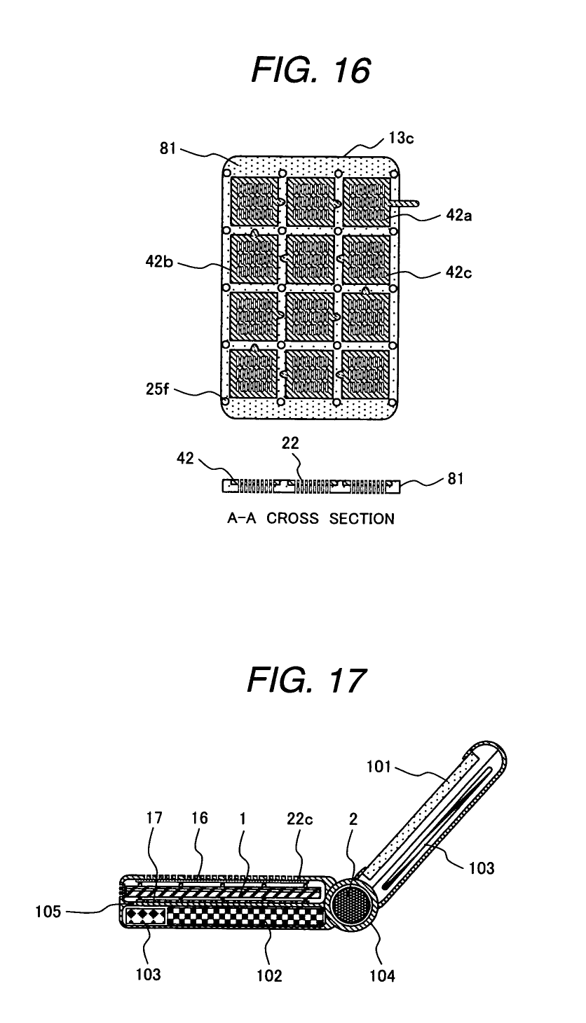

An Embodiment of DMFC for use in a mobile information terminal is to be described. FIG. 14 shows an outline of DMFC according to the invention. The fuel cell 1 has a fuel chamber 12, MEA using sulfomethylated polyether sulfone as an electrolyte not illustrated in the drawing, and a cathode end plate 13c and an anode end plate 13a putting a gasket therebetween, in which a power generation section is mounted only on one side of the fuel chamber 12. A fuel injection tube 28 and an exhaust gas port 4 are provided to the outer circumference of the fuel chamber 12. Further, a pair of output terminals 3 are disposed to the outer periphery of the anode end plate 13a and the cathode end plate 13c. The assembled and constitution of the cell is identical with part constitution shown in FIG. 2 and are different in that the power generation section is mounted only on one side of fuel chamber and that the fuel cartridge holder is not integrated. As the material, a high pressure vinyl chloride is used for the fuel chamber 12, a polyimide resin film is used for the anode end plate and a glass fiber-reinforced epoxy resin is used for the cathode end plate.

FIG. 15 shows a mounting layout of MEA and a cross sectional structure thereof. In DMFC, MEAs having a sizes for the power generation section of 16 mm×18 mm and an entire size of 20 mm×24 mm are mounted by the number of 12 to the surface slits of an anode end plate 13a integrated with the fuel chamber 12. In the fuel chamber, as shown in a cross sectional view along A-A of FIG. 13, a gas-liquid separation module combined with a gas-liquid separation tube 31 is inserted in a fuel distribution groove 27 formed in the fuel chamber 12. One end of the gas-liquid separation module is connected with the exhaust gas port 4. Further, one of the fuel distribution groove 27 is connected with a fuel injection tube 28 situated at the outer circumference of the fuel chamber 12. A current collector not illustrated in FIG. 13 is bonded to the outer surface of the anode end plate 13a so as to be in flush with the surface of the anode end plate. An interconnector 51 and an output terminal 3 are disposed for serially connecting unit cells respectively.

A titanium plate of 0.3 mm thickness is used as the current collector material, and the surface in contact with the electrode is previously cleaned at the surface and then applied with gold vapor deposition of about 0.1 μm. FIG. 14 shows a structure of the cathode end plate 13c for fixing the MEA and serially connecting the respective cells. A glass fiber-reinforced epoxy resin plates of 2.5 mm thickness is used as a substrate 81 for the cathode end plate 13c. Current collectors 42a, 42b, 42c, which are made of titanium of 0.3 mm thickness applied with gold vapor deposition in the same manner as described above, are bonded to the surface of the plate by an epoxy resin. The substrate 81 and the current collector 40 are previously formed with slits 22 for air diffusion and they are bonded so as to be in communication with each other.

The size of the thus prepared power supply is 115 mm×90 mm×9 mm. Further, MEA constituting the power generation section of DMFC, which is assembled into the power supply, can provide a high output compared with conventional DMFC, by using the electrocatalyst in Embodiment 1 as the catalyst material.

### Embodiment 12

FIG. 17 shows an Embodiment of mounting DMFC prepared in Embodiment 11 to a mobile information terminal. The mobile information terminal includes a display 101 with a touch panel type input device, a built-in antenna 103, a first case containing the display 101 and the antenna 103, a main board 102, and a second case containing the lithium ion secondary battery 106 and the main board 102. The main board 102 is provided with the fuel cell module 1, electronic devices and electronic circuits including a processor, volatile and nonvolatile memories, a power controller, a fuel cell and secondary battery hybrid controller and a fuel monitor, a lithium ion secondary battery 106. The fuel cartridge 2 is contained in a hinge 104 serving also as a fuel cartridge holder. The first and the second case are connected by the hinge 104 so as to be foldable.

The power supply mounting section is parted by a partition wall 105 in which the main body 102 and the lithium ion secondary battery 106 are contained in the lower portion and the fuel cell 1 is located in the upper portion. Slits 22c for diffusion of air and cell exhaust gas are formed at the upper side and on the side wall of the casing, and an air filter 107 is disposed to the surface of the slit portions 22c and a water absorbing and rapid drying material 108 is disposed on the partition wall surface in the casing. The air filter is not particularly restricted so long as it is a material having high gas diffusibility and capable of preventing intrusion of powdery dust or the like. A mesh or woven fabric of single strands of synthetic resin is suitable since it does not cause clogging. A single strand mesh of highly water repellent polytetrafluoroethylene is used in this Embodiment.

Since MEA constituting the power generation section of DMFC incorporated in the mobile information terminal can provide higher output compared with conventional DMFCs by using the catalyst material shown in Embodiment 1. The maximum power that can be required for the mobile terminal can be made larger.

Other embodiments of the invention include the following fuel cells.

(1) A direct methanol fuel cell has a membrane electrode assembly (MEA) of reacting methanol in an aqueous methanol solution and oxygen in air. A MEA has a base support for supporting catalytic perticles, a metal formed on the base support with electrically being adsorbed to the support, and catalytic particles supported on the metal and the base support. The metal is capable of removing CO generated upon reaction of the catalyst and methanol.

(2) A direct methanol type fuel cell includes a fuel electrode (anode) for taking in methanol from an aqueous methanol solution, an air electrode (cathode) for taking from oxygen in air, and an electrolyte formed between the fuel electrode and the air electrode. The fuel electrode has a base thereof, a metal electrically in contact with the surface of the base, and a Pt catalyst formed on the metal or on the metal and the base. The metal converts CO generated upon reaction of the Pt catalyst and the methanol into CO₂ and H₂O.

What is claimed is:

1. An electrocatalyst for use in a fuel cell including a carbon material, an intermediate with surface asperities at least on a portion of the surface of the carbon material, and Pt or a Pt-containing alloy particles supported on the intermediate or on the intermediate and the carbon material.

2. The electrocatalyst for use in a fuel cell according to claim 1, wherein the specific surface area per unit weight of the intermediate is from 5 to 100 times the specific surface area per unit weight of the carbon material.

3. The electrocatalyst for use in a fuel cell according to claim 1, wherein the intermediate comprises a single crystal, polycrystal, or amorphous body of a metal containing at least one element selected from Au, Ag, Cu, Pd, Rh, Ir, Ru, Os, Ni, Co, and Ti, or an alloy thereof.

4. The electrocatalyst for use in a fuel cell according to claim 1, wherein the intermediate is from 50 to 90 wt % based on the entire weight of the electrocatalyst.

5. The electrocatalyst for use in a fuel cell according to claim 1, wherein the intermediate has a catalysis effect or a co-catalysis effect to CO oxidation reaction.

6. The electrocatalyst for use in a fuel cell according to claim 1, wherein the supported Pt is from 1 to 25 wt % based on the entire weight of the electrocatalyst.

7. The electrocatalyst for use in a fuel cell according to claim 1, wherein the intermediate comprises a single crystal, polycrystal or amorphous body of oxides, nitrides, sulfides, borides, or silicides containing at least one element selected from Ti, W, Nb, and Ta.

8. The electrocatalyst for use in a fuel cell according to claim 1, wherein the carbon has a specific surface area of from 1 to 200 m²/g, has no or less pores present on the surface, or has a pore diameter on the surface of from 5 to 100 nm.

9. The electrocatalyst for use in a fuel cell according to claim 1, wherein the carbon material has a tubular or fibrous shape.

10. The electrocatalyst for use in a fuel cell according to claim 1, wherein the intermediate is formed by electrochemical reaction in a liquid phase.

11. The electrocatalyst for use in a fuel cell according to claim 1, wherein the Pt or Pt-containing alloy is supported by electrochemical reaction in the liquid phase.

12. An electrocatalyst for use in a fuel cell including a fibrous carbon, a metal of a not uniform thickness and adsorbing in an electrical joined state with the fibrous carbon to at least a portion of the surface of the fibrous carbon, and catalytic particles supported on the fibrous carbon and/or the metal.

13. The electrocatalyst for use in a direct methanol type fuel cell according to claim 12, wherein the metal is capable of eliminating CO.

14. A direct methanol type fuel cell, including the electrocatalyst according to claim 13, wherein the metal is Ru.

15. A membrane electrode assembly including an electrode catalyst layer, the electrode catalyst layer comprises the electrocatalyst according to claim 1.

16. A fuel cell including the membrane electrode assembly according to claim 15.

17. The fuel cell according to claim 16, wherein hydrogen and/or hydrocarbon compound is used as the fuel.

18. A method of manufacturing an electrocatalyst for use in a fuel cell, comprising steps of: forming an intermediate on the surface of carbon by electrochemical reaction in a liquid phase, and supporting Pt or a Pt-containing alloy on the surface of the intermediate or on the intermediate and carbon.

19. The manufacturing method of an electrocatalyst for use in a fuel cell according to claim 18, wherein the Pt or a Pt-containing alloy is supported on the intermediate or on the surface of the intermediate and carbon by electrochemical reaction in liquid phase.

20. The manufacturing method of an electrocatalyst for use in a fuel cell according to claim 18, wherein the specific surface area per unit weight of the electrocatalyst is made by from 5 to 100 times that of the carbon by the intermediate.
